(19) United States
(12) Patent Application Publication
(10) Pub. No.: US 2012/0182213 A1
(43) Pub. Date: Jul. 19, 2012

(54) Control device with wire control for monitor device

(75) Inventor: Jian Ma, Luo Yang City (CN)

(73) Assignee: Luoyang Ruiguang Movie-TV Optic-Electronic Technoloty Co., Ltd.

(21) Appl. No.: 13/066,406

(22) Filed: Apr. 13, 2011

(30) Foreign Application Priority Data
Jan. 14, 2011 (CN) 201120010973.5

(51) Int. Cl. G06F 3/01

(52) U.S. Cl. 345/156

(57) ABSTRACT

A control device with wire control for a monitor, which includes a control body; an audio plug arranged for plugging into an audio jack of the monitor for controlling one or more functions of the monitor through one or more control button; and a resilience and extendable connecting wire electrically connecting between the control body and the audio plug. Accordingly, a user can control different functions of the monitor at a distance from the position at which the monitor is located which is convenience to the user. In addition, the present invention is easy and convenience to carry and is cost-effective.

### BACKGROUND OF THE PRESENT INVENTION

1. Field of Invention

The present invention relates to an electronic device, and more particularly to a control device such as a triggering device which utilizes wire control technology for a capturing or viewing device, such as a LCD monitor.

2. Description of Related Arts

Referring to FIG. 1 of the drawings, a typical circuit diagram for a monitor is illustrated. Obviously, the circuit of a monitor is received inside the monitor. Certain drawbacks existed when this kind of device or system is used.

In particular, in the conventional monitor device or system, all the functions of the monitor are controlled through control buttons such as press buttons or rotational buttons provided on the monitor itself. If an operator is at a distance from the monitor to operate the monitor, he or she has to move to the position at which monitor is located in order to operate the monitor, making the monitor a very inconvenience device for the user.

### SUMMARY OF THE PRESENT INVENTION

The invention is advantageous in that it provides a control device with wire control for monitor which allows a user to control different functions of the monitor through the control device at a distance from a position at which the monitor is located.

The invention is advantageous in that it provides a control device which utilizes wire control technology such that the control device is capable of communicating with any monitor with an audio input such as an audio jack directly without any additional circuitry requirements in the monitor, thereby the control device is universal for use with any monitor with an audio input.

The invention is advantageous in that it provides a control device which comprises a connecting wire which is resilient and flexible in nature such that a distance between the control device and the monitor with which the control device is connected to is adjustable.

The invention is advantageous in that it provides a control device which comprises a positioning connector on the control device for securing the control device into position.

The invention is advantageous in that it provides a control device which is handy in size arranged for single-handed use in such a manner that a user can hold the control device with one hand and control or trigger a control button on the control device with a finger.

The invention is advantageous in that it provides a control device which comprises a control button such as a rotation button for controlling a plurality of functions of the monitor with which the control device is connected to.

The invention is advantageous in that it provides a control device which comprises a control button which is a rotation button for controlling a plurality of functions of the monitor with which the control device is connected to, wherein the rotation button defines a 360° rotational angle arranged for controlling the plurality of functions of the monitor.

Additional advantages and features of the invention will become apparent from the description which follows, and may be realized by means of the instrumentalities and combinations particular point out in the appended claims.

According to the present invention, the foregoing and other objects and advantages are attained by a control device with wire control for a monitor, comprising:

a control body;

an audio plug arranged for plugging into an audio jack of the monitor for controlling a plurality of functions of the monitor through at least one control button; and

a resilience and extendable connecting wire electrically connecting between the control body and the audio plug.

Preferably, the control body comprises a positioning hole arranged for securing the control body into position. In particular, a cord-like connector such as a string, a cord, or a VELCRO can be used to penetrate through the positioning hole for positioning or tying the control body such that the control body is secured into position.

Preferably, the control body is sized to fit for single-handed control such that a user can hold the control body with one hand and trigger the control button of the user with a finger.

Preferably, the monitor includes a plurality of control buttons, such as press buttons or rotation buttons, for controlling the plurality of functions of the monitor respectively.

Preferably, the control button is arranged for controlling a zooming function of the monitor.

Preferably, the monitor is a portable VCD. In particular, the control button is arranged for controlling the play and select functions of the portable VCD.

The present invention is advantageous in that a user can control different functions of the monitor at a distance from the position at which the monitor is located which is convenience to the user. In addition, the present invention is easy and convenience to carry and is cost-effective.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an illustration of a circuitry diagram inside a conventional monitor.

FIG. 2 is a structural illustration of a control device arranged for use with a monitor device according to a preferred embodiment of the present invention.

FIG. 3 is a schematic illustration of a control device connected with a monitor device according to the above preferred embodiment of the present invention.

FIGS. 4A, 4B and 4C are illustrations of the control device showing a front view and two side views according to the above preferred embodiment of the present invention.

### DETAILED DESCRIPTION OF THE PREFERRED EMBODIMENT

Referring to FIG. 2 of the drawings, a control device with wire control arranged for use with a monitor device according to a preferred embodiment of the present invention is illustrated. According to the preferred embodiment of the present invention, the control device with wire control comprises a control body 21 which is the main body of the control device, and an audio connector 22 such as an audio plug which is arranged for connecting the control device and the monitor device and is capable of signal transmission through wire control. The control body 21 comprises at least one control button 211 arranged for controlling the monitor device M. In other words, the monitor device has a preset number of functions which is controllable through the control button 211 of the control body 21. The audio connector 22 is connected with the control body 21 through a connecting wire 23, wherein the connecting wire 23 is a resilient and extendable wire or cable such as a spring cable for electrically connecting the audio connector 22 and the control body 21. In other words, the connecting wire 23 does not only electrically bridging the audio connector 22 and the control body 21, but also provides a flexibilities in length adjustment between the audio connector 22 and the control body 21. The audio connector 22 is arranged for connecting to the monitor device M through an audio input of the monitor device. For example, the audio connector 22 is embodied as an audio plug which is connected to the audio input, such as an audio jack, of the monitor device simply through plugging the audio plug directly to the audio jack.

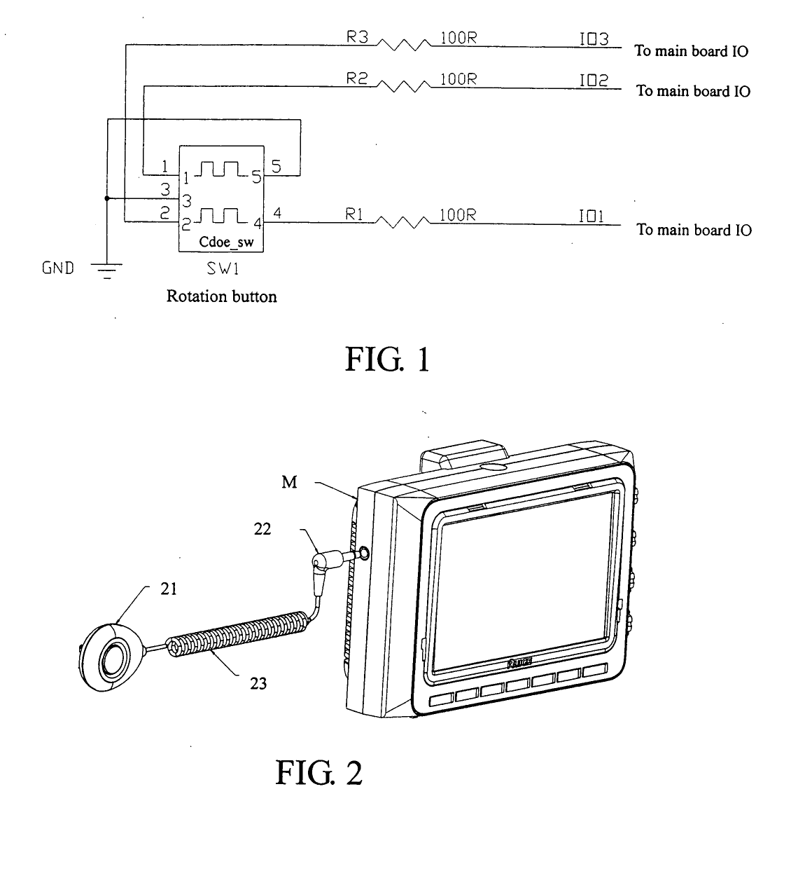

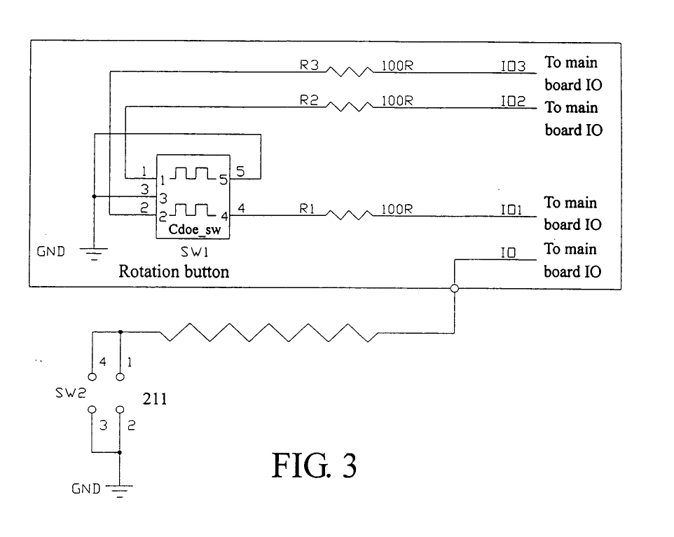

Referring to FIG. 3 of the drawings, a schematic illustration of the control device, which is not positioned inside the monitor and is connected with a monitor device, according to the above preferred embodiment of the present invention is illustrated, that the following description is better illustrated with reference to FIG. 2 of the drawings. As shown in FIG. 3, the portion enclosed by a frame is similar to the one as shown in FIG. 1 of the drawings, which is a circuitry inside a monitor device. The portion below the frame is a circuitry of the control device, which is an external control device positioned outside the monitor device, arranged for use with the monitor. According to the preferred embodiment of the present invention, the control device comprises one or more control button which is capable of controlling different functions of the monitor M with which the control device is connected. For example, the control button 211 can be a press button which is arranged for controlling a zooming function of the monitor. In other words, through connecting the press button of the control device with the monitor, a user can simple use the press button to enlarge or reduce a scale of the image shown on the monitor. The audio connector 22 is electrically communicates with the control body 21 through the connecting wire 23 and is electrically connecting to the audio input of the monitor M simply through directly plugging the audio connector 22 into the audio input. The audio input refers to an output terminal of the main board I/O which is connected to the control device, as shown below the frame in FIG. 3 of the drawings. This configuration is advantageous in that the circuitry inside the monitor device is remained unchanged and the control device is capable of having simple and direct connection with the monitor device to control different functions of the monitor device, while the manufacture cost is relatively low.

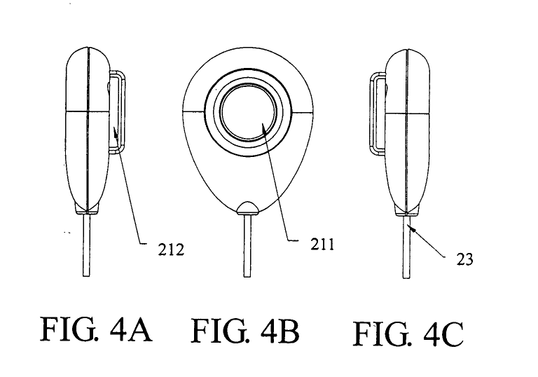

Referring to FIGS. 4A, 4B, and 4C of the drawings, a front view and two side views of the control device according to the above preferred embodiment of the present invention are illustrated. According to the preferred embodiment, the control body 21 comprises a positioning connector 212 provided thereon for securing the control body 21 into position. For example, the positioning connector 212 can be embodied as a positioning hole provided on a side of the control body 21. In general, it is sufficient for the positioning connector 212 to have one to two positioning holes for securing the control body 21 into position. In other words, preferably, the positioning connector 212 includes one to two positioning holes serving as connecting holes for connection arrangement such that the control body 21 can be secured into position through the positioning connector 212. In particular, an elongated unit such as a VELCRO, a string, a cord or the like can be used to penetrate through the connecting hole and to secure the control body 21 into position. Conversely, a user can also hold the control body 21 with his or her hand without using the positioning connector 212 to secure the position of the control body 21. It is worth mentioning that a plurality of control buttons 211 can be provided to control a plurality of functions of the monitor M respectively. On the other hand, it is also possible to have only one control button 211 to control a plurality of functions of the monitor M. In particular, the control button 211 can provided a plurality of control portions thereon for controlling a plurality of functions of the monitor M. For example, when only one control button 211 is provided on the body 21 for controlling a plurality of functions of the monitor device, four control portions can be provided at four different directions on the control button for triggering four different functions of the monitor device. It is worth mentioning that the physical appearance and form of the control button 211 is not limited by the figural illustration as long as the control button 211 is capable of controlling or triggering one or more functions of the monitor device with which the control device is connected. According to another preferred embodiment of the present invention, the monitor device M is a portable VCD and the control button 211 is utilized to control or trigger the play and selection functions.

In addition, the control body is sized to fit for single-handed control such that a user can hold the control body with one hand and trigger the control button of the user with a finger. For example, as shown in FIG. 4B, the control body 21 is an oval-shaped structure in which the longest width is 25 mm-35 mm, the longest length is 30 mm-40 mm, and its thickness is 10 mm-15 mm, wherein the control button 211 is provided on a front side of the control body 21 which can have a round-shaped structure, an oval-shaped structure, or any other structures. Preferably, the control body has a substantively flattened and smooth body.

It is worth mentioning that the control device according to the preferred embodiment of the present invention is advantageous in that a user can control different functions of the monitor at a distance from the position at which the monitor is located which is convenience to the user. In addition, the control device is easy and convenience to carry and is low cost. There is no need to alter the configuration of any monitor because the control device according to the preferred embodiment of the present invention comprises an audio connector 22 which is capable of directly plugging into the audio jack of the monitor device. In other words, whether the monitor device is a VCD player, a surveillance monitor, a LCD monitor, or a DVD monitor, the control device of the present invention can be plugged into the monitor device and used immediately without any hassle. For example, when the monitor is a surveillance monitor which is positioned at a location which is not convenience for the user, the user can still control the zooming function through the control device at a distance from the location of the surveillance monitor.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A control device with wire control for a monitor device which comprises an audio input, comprising:
a control body which comprises at least one control button on said control body, wherein said control button is arranged for controlling a plurality of functions of the monitor device when said control device is connected to the monitor device through the audio input;
an audio connector arranged for plugging into the audio input of the monitor directly; and
a connecting wire which is resilient and expandable connecting between said audio plug and said control body,
thereby said control body is connected to the monitor through plugging said audio plug directly into the audio input of the monitor such that said control button is capable of controlling the functions of the monitor through wire control.

2. The control device, as recited in claim 1, wherein said control body has a connecting hole provided thereon for securing said control body into position.

3. The control device, as recited in claim 2, further comprising an elongated unit arranged for passing through said connecting hole for tying said control body into position.

4. The control device, as recited in claim 1, wherein said control body is sized to fit for single-handed control and has a substantively flattened and smooth body.

5. The control device, as recited in claim 1, wherein said control body comprises more than one control buttons, each of said control button is arranged for controlling one particular function of the monitor device.

6. The control device, as recited in claim 1, wherein said control button is arranged for controlling a zooming function of the monitor device through wire control.

7. The control device, as recited in claim 1, wherein the monitor device is a portable VCD.

8. The control device, as recited in claim 1, wherein said control button is arranged for controlling a play function and a song selection function of the VCD through wire control.

9. A control device with wire control for a monitor device which comprises an audio input, comprising:
a control body, which comprises at least one control button provided thereon;
a connecting wire having an elongated body which defines a length and two ends of said connecting wire, connected to said control body through a first end of said connecting wire such that said control body is capable of positioning at a distance from the monitor;
an audio connector connected to a second end of said connecting wire such that said control body is connected to said audio connector, wherein said audio connector is arranged for connecting to the monitor through directly plugging said audio connector to the audio input of the monitor such that said control button on said control body is capable of communicating with the monitor through wire control and controlling at least one function of the monitor while said control body is distanced from the monitor through the length of said connecting wire.

10. The control device, as recited in claim 9, wherein said control button is a rotation button on said control body defining a 360° rotation angle for said rotation button such that said control button is capable of triggering a plurality of different functions of the monitor through said rotation button.

11. The control device, as recited in claim 9, wherein said connecting wire is a resilience and expandable cable.

12. The control device, as recited in claim 10, wherein said connecting wire is a resilience and expandable cable.

13. The control device, as recited in claim 11, wherein said audio connector is an audio plug of conventional configuration, thereby said control button of said control body is capable of having wire control communications with the monitor device into which said audio plug is plugged, thereby said control device is a universal device for connecting to any audio jack of different monitor devices.

14. The control device, as recited in claim 12, wherein said audio connector is an audio plug of conventional configuration, thereby said control button of said control body is capable of having wire control communications with the monitor device into which said audio plug is plugged, thereby said control device is a universal device for connecting to any audio jack of different monitor devices.

15. The control device, as recited in claim 13, wherein said control body comprises a positioning connector provided thereon for securing said control body into position.

16. The control device, as recited in claim 14, wherein said control body comprises a positioning connector provided thereon for securing said control body into position.

17. The control device, as recited in claim 16, wherein said positioning connector defines at least one connecting hole for securing said control body into position.

18. The control device, as recited in claim 15, wherein said control body is an oval body which is a flattened body and has a substantively smooth surface.

19. The control device, as recited in claim 17, wherein said control body is an oval body which is a flattened body and has a substantively smooth surface.

20. The control device, as recited in claim 18, wherein said control body is sized to fit for single-handed control and said control button is arranged for controlling a zooming function of the monitor device.
